(19) United States
(12) Patent Application Publication
(10) Pub. No.: US 2004/0138995 A1
(43) Pub. Date: Jul. 15, 2004

(54) Preparation of an advanced report for use in assessing credit worthiness of borrower

(75) Inventors: Brian F. Hershkowitz, Santa Barbara, CA (US); Jeffrey S. Harris, Jacksonville, FL (US); Jay E. Liebig, Malibu, CA (US); Michael Steven Moshay, Los Angeles, CA (US); Charles T. Murphy, Kingston, NY (US)

Correspondence Address: FOLEY AND LARDNER, SUITE 500, 3000 K STREET NW, WASHINGTON, DC, 20007, US

(73) Assignee: Fidelity National Financial, Inc.

(21) Appl. No.: 10/684,804

(22) Filed: Oct. 15, 2003

Related U.S. Application Data
(60) Provisional application No. 60/418,351, filed on Oct. 16, 2002.

(51) Int. Cl. G06F 17/60

(52) U.S. Cl. 705/38

(57) ABSTRACT

A method of and program product for generating a report for use in assessing the credit worthiness of a borrower in a potential financing transaction with a lender, where the method comprises obtaining personal credit information about the borrower from a plurality of credit reporting services and combining the credit information, matching the borrower's address with a property in a database containing property information and obtaining property information pertaining to the matched property from the database. The method also includes obtaining value information about the matched property, aggregating the combined credit information about the borrower, the property information pertaining to the matched property and the value information pertaining to the matched property. A report is generated from the aggregated data.

### PRIORITY

The present application claims the benefit of priority to a U.S. Provisional Patent Application Serial No. 60/418,351 entitled “The 4^{th} Repository™—Preparation of a Quadmerge Report” filed on Oct. 16, 2002, the contents of which are incorporated herein by reference.

### BACKGROUND OF THE INVENTION

A. Field of the Invention

The present invention is directed to assessing the credit worthiness of a borrower. Specifically the invention is directed to a method of generating an advanced report for use in assessing the credit worthiness of a borrower in a potential financing transaction with a lender. The advanced report contains credit information and collateral information.

B. Description of the Related Art

One of the first steps a lender performs in assessing whether to provide financing to a potential borrower is determining the borrower's credit worthiness. This often involves obtaining the personal credit history of the potential borrower from one or more credit reporting agencies. One of the deficiencies of the current methods is that they require the lender to contact each of the major credit reporting agencies. Another deficiency is that the lender is not provided with information regarding the borrower's collateral; specifically, no real property information or valuation is provided with the credit report.

### SUMMARY OF THE INVENTION

Having identified the aforementioned problems in the existing methods of value estimation, the inventors have developed the method of the present invention. As described in the present application, the invention provides a method of generating an advanced report for use in assessing the credit worthiness of a borrower in a potential financing transaction with a lender. The advanced report contains credit information and collateral information.

The present invention discloses a method and program product for generating a report for use in assessing the credit worthiness of a borrower in a potential financing transaction with a lender, where the method comprises obtaining personal credit information about the borrower from a plurality of credit reporting services and combining the credit information, matching the borrower's address with a property in a database containing property information and obtaining property information pertaining to the matched property from the database. The method also includes obtaining value information about the matched property, aggregating the combined credit information about the borrower, the property information pertaining to the matched property and the value information pertaining to the matched property. A report is generated from the aggregated data.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 is flowchart illustrating the preferred embodiment of the method of the present invention; and

FIG. 2 shows an example of information retrieved from a public records database under the present invention.

### DETAILED DESCRIPTION OF THE INVENTION

The present invention is now described in detail with reference to the above-mentioned figures. The present invention can be summarized as a method of generating an advanced report for use in assessing the credit worthiness of a borrower in a potential financing transaction with a lender. The advanced report contains credit information and collateral information.

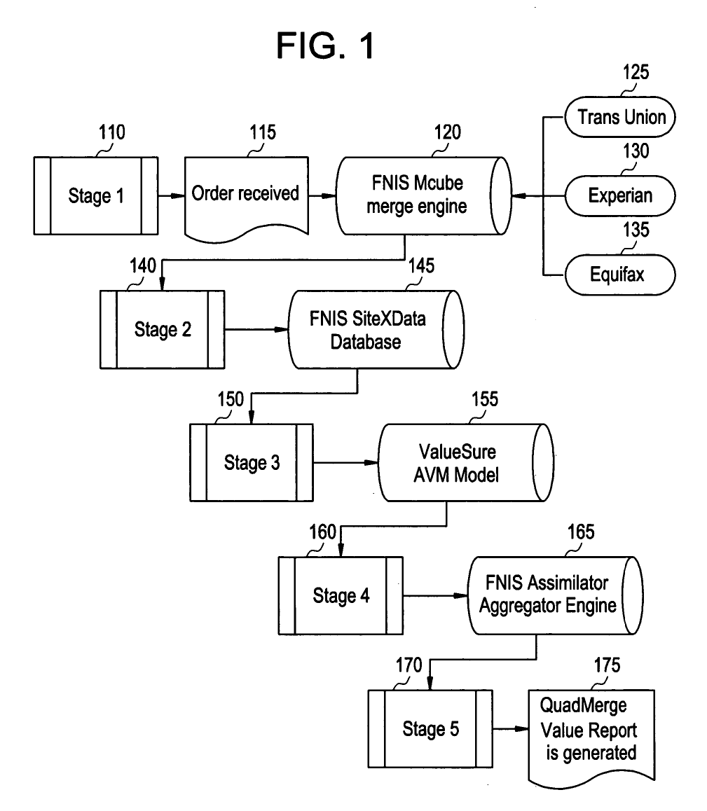

FIG. 1 is a flowchart illustrating the preferred embodiment of the method of the present invention. Step 110 shows the first stage of the invention. In this stage, an order is received 115 from a customer who wants credit information regarding a borrower. This customer is often a lender in the financing transaction involving the prospective borrower. The order contains information about the borrower such as his legal name, social security number and residential address. This information is parsed by a merged engine 120. The merge engine may be a stand-alone device or may be embodied in a server. The merge engine then communicates with a plurality of credit reporting agencies in order to obtain credit information regarding the borrower. Presently, and in the preferred embodiment, there are three major credit reporting agencies from which credit information regarding the borrower will be collected. These agencies are shown in FIG. 1 as Trans Union 125, Experian 130, Equifax 135. It will be apparent to those skilled in the art that any number of credit reporting agencies or similar sources of information can be queried and the present invention is not limited to the number of such agencies. The plurality of credit reporting agencies can be queried sequentially or, as in the preferred embodiment, in parallel. Such parallel queries allow for improved speed and efficiency in the final report generation.

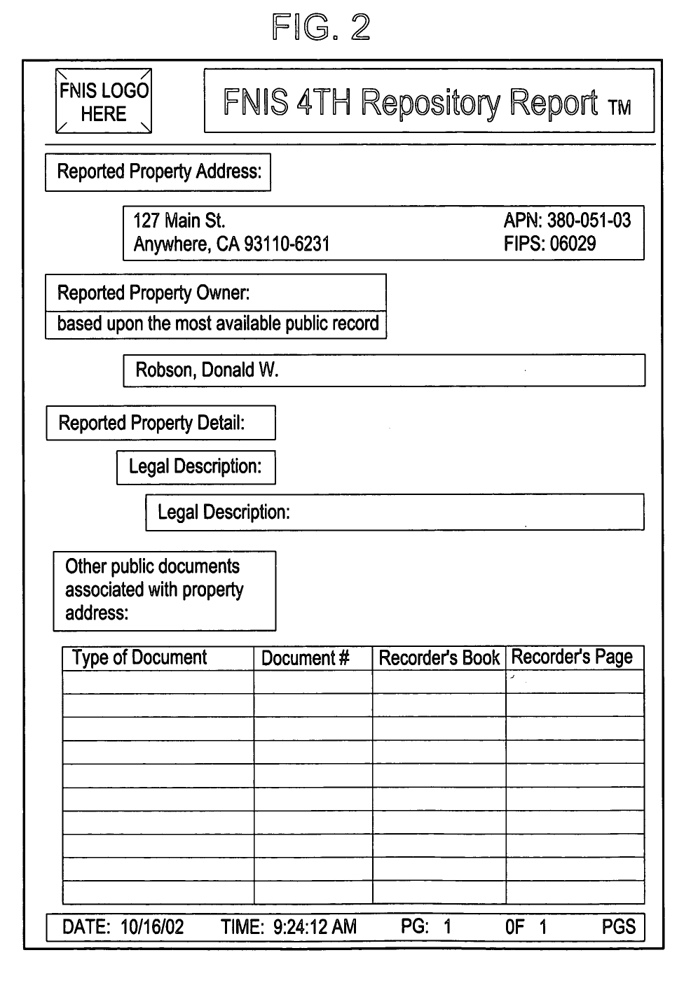

Once the information regarding the borrower has been collected, the invention proceeds to the second stage 140. In this stage, the borrower's legal address is used to query a database 145 containing property information, preferably from public records. This public record's database 145 should include information from a large number of real estate properties. The information collected in the database about these properties should include the assessed value, the legal description, the number of bedrooms and bathrooms, the property description including type of construction and style, and other descriptive attributes. Such information can be collected from state and municipal records, county assessors, tax authorities, and also from proprietary sources. The borrower's address is matched with the property in the database. This allows the invention to obtain property information regarding the borrower's residence. FIG. 2 illustrates information retrieved from the public records database 145 according to the present invention. This information is used in preparing the final report.

The invention then proceeds to the third stage 150. In this stage, a present valuation of the matched property is obtained. Those skilled in the art will recognize that many methods exist for valuing real property and any such method may be used herein to generate the value of the matched property. One example of current methodology is Freddie Mac's Home Value Estimator (HVE). The HVE produces a computer-generated estimate of value by entering subject property characteristics, comparable sales in the immediate area of the subject, and other data into a proprietary regression model to produce an estimate of value. In the preferred embodiment, the value information provided by the value model 155 is based on such factors as an assessed value of the property and appraised value of the property as well as historic valuation data of the property. The value information shown in the generated report includes an estimated market value, a high value and a low value in addition to a level of confidence in the valuation (see Table 1).

The invention then proceeds to the fourth stage 160. In this stage, an aggregator engine 165 combines the credit information obtained from the credit reporting agencies about the borrower with the property information obtained from database 145 pertaining to the matched property and the value information obtained from value model 155 pertaining to the matched property.

The invention then proceeds to the fifth stage 170. In this stage, a report is generated from the aggregated data. This report is valuable to both banks and mortgage brokers in validating and qualifying the credit worthiness of the prospective loan client since it extends beyond the traditional credit information available to include critical collateral information of the prospective borrower's residential property value. It combines public information regarding a property with credit information regarding a borrower. It significantly reduces the cost to the customer. For example, absent the present invention, the customer would need to contact multiple locations to order separate reports and maintain separate licenses in order to collect information from various sources. The cost of doing so would be almost twice that of obtaining the same information under the present invention. The report is formatted in a manner that mortgage brokers, bankers, and lenders can quickly assess a borrower's credit history, determine if all the lien holders on the subject property have been identified, and whether the subject property can be used as collateral for the loan period. All of this valuable information is contained in one report. Table 1 at the end of this specification provides an example of such a final generated report.

The method of the present invention may be performed by a central server. This server would contain or communicate with the various engines and database described above. The server would communicate via any known means with the credit reporting agencies. Customers of the service could submit orders to the server via the internet or any other known method. The report generated in accordance with the method of the present invention could be communicated to the customer via the internet or any known method. The present invention also includes a program product for generating such a report where the product comprises machine readable program code for causing, when executed, a machine to perform the method of the present invention as described above.

Referring again to FIG. 1, it would be apparent to one skilled in the art that the various stages of the present invention can be performed in any order before the generation of the report in stage five.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

TABLE 1
Advanced Report Generated by Method of Present Invention

| | |
|---|---|
| FIDELITY NATIONAL CREDIT SVCS | File No: AHA99599 |
| MATCH MERGE INFILE CREDIT REPORT | Date: Oct. 09, 2003 |
| Prepared for: TEST FNCS WEB SOLUTION/KINGSTON NY | Attn: LORI CARL |
| Repositories: Experian; Trans Union; Equifax | Case: |

Borrower: JONATHAN Q CONSUMER SSN: 548-60-3388 AGE:
Current Address: 460 BRIGHTON SALINAS, CA, 93901

| *** Summary *** | | Monthly | Curr | Curr Was | | | | Now Derog | | | | Clsd | Unrtd |
|---|---|---|---|---|---|---|---|---|---|---|---|---|---|
| Acct Type | Balance | Pay | Acct | 30 | 60 | 90+ | SD | 30 | 60 | 90+ | SD | Paid | Misc |
| Revolving | $14657 | $435 | 21 | 0 | 0 | 0 | 0 | 0 | 0 | 0 | 0 | 8** | 1 |
| Installment | $31667 | $1453 | 1 | 0 | 0 | 0 | 0 | 2 | 1 | 0 | 0 | 43 | 0 |
| Real Estate | $253700 | $3278 | 4 | 0 | 0 | 0 | 0 | 0 | 0 | 0 | 0 | 6 | 0 |
| Net 30 | $1020 | $0 | 0 | 0 | 0 | 0 | 0 | 0 | 0 | 0 | 2 | 0 | 0 |
| Unknown | $250 | $0 | 0 | 0 | 0 | 0 | 0 | 0 | 0 | 0 | 1 | 0 | 0 |
| Totals | $301294 | $5166 | 26 | 0 | 0 | 0 | 0 | 2 | 1 | 0 | 3 | 57** | 1 |

| | | | | | |
|---|---|---|---|---|---|
| 90 | Total Tradelines | | | | |
| 114 | Inquiries. | 1-24 Month History: | 2 × 30 | 0 × 60 | 3 × 90+ |
| 3 | Public Records. | >24 Month History: | 5 × 30 | 2 × 60 | 25 × 90+ |
| | | Unknown History: | 0 × 30 | 0 × 60 | 0 × 90+ |

Revolving Credit Available: $76523 (82% of total revolving credit)
File Established: Oldest Account: 01/68 Newest Account: Jul. 01, 2003
PUBLIC RECORDS HAVE BEEN SYSTEMATICALLY CHECKED BY THE ABOVE ACCESSED BUREAUS
SD Seriously Delinquent contains such items as; Charge Offs, Collection Accts,
Foreclosures, Reposessions, etc . . .
** Contains Derogatory Credit Information.
[BUREAU IDENTIFIERS]

| | |
|---|---|
| TUC-01 | CONSUMER, JOHN Q SSN: 548-60-3388 DOB: 1952 |
| | AKA: LORENZ, JASON, M |
| | AKA: CONSUMER, JIM |
| | CURR ADD: Aug. 01, 2002, 8374 S EVERETT APT AD LITTLETON, CO, 80128 |
| | PREV ADD: Sep. 01, 2001, 2929 GREEN CASTLE PORTLAND, OR, 97232 |
| | PREV ADD: N/A, 111 MAIN ATLANTA, GA, 30349 |
| | CURR EMP: N/A, M |
| | PREV EMP: N/A, JONATHAN Q CONSUMER |
| TUC-02 | CONSUMER, JON SSN: 548-60-3388 DOB: Jan. 01, 1951 |
| | AKA: CONSUMER, JANE |
| | CURR ADD: Oct. 01, 2002, 1223 PLEASANT SCHENECTADY, NY, 12345 |
| | PREV ADD: Jul. 01, 2002, 10655 BIRCH BURBANK, CA, 91502 |
| | PREV ADD: N/A, 15442 DEL AMO CARD SERVICES TUSTIN, CA, 92780 |
| | PREV EMP: N/A, M |
| | PREV EMP: N/A, UNITED STATES POSTAL SERVICE WICHITA, KS [MAIL CARRIER] |
| TUC-03 | SMITH, JOHN QUINCY 3 SSN: 548-60-3388 DOB: 1957 |
| | AKA: CONSUMER, JONATHAN,A,3 |
| | AKA: CONSUMER, JOUH |
| | CURR ADD: May 01, 2003, 123 CHERRY STREET ABSECON, NJ, 08201 |
| | PREV ADD: Dec. 01, 2002, 4727 WILSHIRE LEONARD LEE TEST A APT A414 LOS |
| | ANGELES, CA, 90010 |
| | PREV ADD: N/A, 2035 BROADWAY CANANDAIGUA, NY, 14424 |
| | PREV EMP: N/A, MELLON BANK |
| | PREV EMP: N/A, AJAX HARDWARE |
| EXP-01 | JONATHAN QUINCY CONS, SSN: 999-99-9990 DOB: 1951 |
| | AKA: SSN: 234-56-7891 |
| | AKA: SSN: 123-45-6789 |
| | AKA: JACK CONSUMER |
| | AKA: JOHN SMITH |
| | AKA: JONATHAN SMITH JONES JR |
| | CURR ADD: 06/95, 10655 N BIRCH ST BURBANK, CA, 91502-123 |
| | PREV ADD: N/A, 1314 SOPHIA LN APT 3 SANTA, AN, 92708-567 |
| | PREV ADD: N/A, 2600 BOWSER ST #312 LOS, AN, 90017-987 |
| | CURR EMP: N/A, AJAX HARDWARE LOS ANGELES CA, 90019 |
| | PREV EMP: 05/91, BELL AUTOMOTIVE BURBANK CA, 91503 |

[BUREAU SCORING]

| | |
|---|---|
| TUC-01 | MODEL: EMPIRICA (+) |
| | REJECT CODE: 2 FILE NOT SCORED BECAUSE SUBJECT IS DECEASED. |
| TUC-02 | MODEL: EMPIRICA (+) |
| | REJECT CODE: 2 FILE NOT SCORED BECAUSE SUBJECT IS DECEASED. |
| TUC-03 | MODEL: EMPIRICA (+) |
| | REJECT CODE: 2 FILE NOT SCORED BECAUSE SUBJECT IS DECEASED. |
| EXP-01 | MODEL: EXPERIAN/FAIR, ISAAC MODEL SCORE: 0700 (+) |
| | FACTOR: 22 ACCOUNT(S) NOT PAID AS AGREED AND/OR LEGAL ITEM FILED. |
| | FACTOR: 13 LENGTH OF TIME (OR UNKNOWN TIME) SINCE ACCOUNT |
| | DELINQUENT. |
| | FACTOR: 18 NUMBER OF ACCOUNTS DELINQUENT. |
| | FACTOR: 34 |
| EXP-01 | MODEL: EXPERIAN NATIONAL RISK SCORE SCORE: 0502 (+) |
| | FACTOR: 19 AVERAGE AGE OF ACCOUNTS. |
| | FACTOR: 35 DELINQUENCY ON BANK INSTALLMENT LOANS. |
| | FACTOR: 01 TOO FEW ACCOUNTS NOW CURRENT. |
| | FACTOR: 08 PRESENCE OF NON-SATISFACTORY RATINGS ON ACCOUNTS OR LACK |
| | OF OPEN ACCOUNTS. |
| EXP-01 | MODEL: EXPERIAN/MDS BANKRUPTCY MODEL SCORE: 0925 (+) |
| | FACTOR: K RATIO OF BANK REVOLVING BALANCES TO CREDIT LIMITS OR |
| | LACK OF BANK REVOLVING ACCOUNT INFORMATION. |
| | FACTOR: C PRESENCE OF DEROGATORY ACCOUNTS. |
| | FACTOR: H RECENTLY ACTIVE OR LACK OF BANK, RETAIL OR FINANCE |
| | ACCOUNTS. |
| | FACTOR: B PRESENCE OF DELINQUENT ACCOUNTS. |

[BUREAU MESSAGES]
EXP-01 FACS+

FROM Mar. 01, 2003 # OF INQS WITH THIS SSN = 08
FROM Mar. 01, 1996 # OF INQS WITH THIS ADDR = 15
FIRST YEAR POSSIBLE FOR SSN ISSUANCE: 1965
LAST YEAR POSSIBLE FOR SSN ISSUANCE: 1966

PHONE ANSWERING SERVICE:/ABC ANSWER-ALL/10655 N BIRCH ST/BURBANK CA
91502/818.555.1212
EXP-01 FACS+
COMMERCIAL BUSINESS ADDRESS:/J&J INVESTMENTS/2600 BOWSER ST #312/LOS ANGELES CA
90017/213.111.2222
EXP-01 FACS+

DOB: Jan. 10, 1951 DOD: Mar. 30, 1996
CKPT: INPUT SSN RECORDED AS DECEASED

EFX-01 NO RECORD FOUND - CHECK INPUT FOR ACCURACY
TUC-01 TRANS-ALERT: RECORDED INQUIRIES ALERT
TUC-01 TRANS-ALERT: CURRENT HOUSE NUMBER IS A MISMATCH
TUC-02 TRANS-ALERT: RECORDED INQUIRIES ALERT
TUC-02 TRANS-ALERT: CURRENT HOUSE NUMBER IS A MISMATCH
TUC-03 TRANS-ALERT: RECORDED INQUIRIES ALERT
TUC-03 TRANS-ALERT: CURRENT HOUSE NUMBER IS A MISMATCH
TUC-03 TRANS-ALERT: SURNAME ALERT - MISMATCH

| COURT NAME | ECOA | PLAINTIFF | ACCOUNT STATUS | |
|---|---|---|---|---|
| DOCKET NUMBER | BC | DATE FILED | STATUS DATE | AMOUNT |
| [PUBLIC RECORD ITEMS] | | | | |
| U S BANKRUPTCY COURT | 2 | | BK 13-FILE | 100000 |
| 35054539906234561 | B | 02/93 | EXP01 | |
| SO CALIF DISTRICT COU | 1 | | CO LN REL | 12450 |
| 45078321 | B | 06/94 | 07/95 | |
| | | | EXP01 | |
| COUNTY SPR CT SANTA A | 1 | ALLIED COMPANY | JUDGMENT | 1200 |
| 7505853 | B | 09/93 | EXP01 | |

| | | | | | | | | | | | | |
|---|---|---|---|---|---|---|---|---|---|---|---|---|
| | | | | | | | | HISTORY | | | | |
| ACCOUNT NAME | ECOA | TYPE | OPEN | LIMIT | PAST | | | ACCOUNT STATUS | | | | |
| ACCOUNT NUMBER | BC | TERM | LAST | HIGH | PMT | BAL | DATE | SOURCE | 30 | 60 | 90 | MOP |

[DEROGATORY ACCOUNTS]

| | | | | | | | | | | | | |
|---|---|---|---|---|---|---|---|---|---|---|---|---|
| MOUNTAIN BK | 2 | SEC | 03/93 | 43225 | 956 | 19330 | 12/96 | 39 MONTH | 03 | 00 | 00 | I-2 |
| 3562A0197325346R | B | 60 | 11/96 | | 956 | | | 30 3 TIMES | | | | |
| | | | | | | | | EXP01 | | | | |

| | |
|---|---|
| 211111121111 | 12/96 = 30 05/96 = 30 |
| 111111111111 | |
| 1 | |
| | MAX DELINQ = 09/94 |

| | | | | | | | | | | | | |
|---|---|---|---|---|---|---|---|---|---|---|---|---|
| CENTRAL BANK | 1 | AUT | 12/93 | 22350 | 465 | 11050 | 06/96 | 31 MONTH | 01 | 00 | 00 | I-2 |
| 23802654388 | B | 48 | 05/96 | | 465 | | | 30 DAY DEL | | | | |
| | | | | | | | | EXP01 | | | | |

| | |
|---|---|
| 211111111111 | 06/96 = 30 |
| 111111111111 | |
| 1 | |

| | | | | | | | | | | | | |
|---|---|---|---|---|---|---|---|---|---|---|---|---|
| TROJAN PROFE | 1 | COL | 05/01 | | 615 | 615 | 07/01 | 00 MONTH | 00 | 00 | 00 | O-9 |
| 6811123654575324 | B | | | 750 | | | | COLL ACCT | | | | |
| | | | | | | | | TUC02 | | | | |

P.O. BOX 1270
LOS ALAMITOS CA 90720
(714-220-6716)
*** PLACED FOR COLLECTION ***
Client Name: TROJAN PROFESSIONAL SERVICES

| | | | | | | | | | | | | |
|---|---|---|---|---|---|---|---|---|---|---|---|---|
| TAL LEWIS | 1 | COL | 06/97 | | 405 | 405 | 07/97 | 00 MONTH | 00 | 00 | 00 | O-9 |
| 20198 | B | | | 405 | | | | COLL ACCT | | | | |
| | | | | | | | | TUC01 | | | | |
| 580 E. SAN | | | | | | | | | | | | |

COVINA CA 91723
(818-966-8341)
*** PLACED FOR COLLECTION ***
Client Name: TAL LEWIS INCORPORATED

| | | | | | | | | | | | | |
|---|---|---|---|---|---|---|---|---|---|---|---|---|
| GUADJARA JWL | 1 | ISC | 11/99 | | 0 | 287 | 07/03 | 44 MONTH | 02 | 00 | 01 | I-2 |
| 128099 | B | 10 | 02/03 | 500 | 32 | | | DEL WAS 90 | | | | |
| | | | | | | | | TUC02 | | | | |

| | |
|---|---|
| 2X4XXXXXXXXX | 07/03 = 30 05/03 = 90 |
| XXXXX11211XX | 12/01 = 30 |
| | MAX DELINQ = May 01, 2003 |
| 200 E 4TH ST | |
| SANTA ANA CA 92701 | |
| (714-547-5622) | |

| | | | | | | | | | | | |
|---|---|---|---|---|---|---|---|---|---|---|---|
| CREDIT AND COLLE | 2 | UNK | 09/94 | 500 | 250 | 04/96 | 20 MONTH | 00 | 00 | 00 | U-9 |
| 98E543182136 | B | UNK | 04/96 | | | | COLL ACCT | | | | |
| | | | | | | | EXP01 | | | | |
| 999999999999 | | | | | | | | | | | |
| 99999999 | | | | | | | | | | | |

Client Name: DR. JOHN KILDARE

| | | | | | | | | | | | |
|---|---|---|---|---|---|---|---|---|---|---|---|
| BAY COMPANY | 2 | CHG | 01/68 | 1400 | 0 | 05/96 | 99 MONTH | 01 | 01 | 04 | R-7 |
| 525556601 | B | REV | 05/96 | | | | DELINQ 180 | | | | |
| | | | | | | | EXP01 | | | | |

| | |
|---|---|
| 755543211111 | 04/96 = 120 30/96 = 120 02/96 = 120 01/96 = 90 12/95 = 60 |
| 111111111111 | 11/95 = 30 |

*** ACCOUNT PREVIOUSLY IN DISPUTE - NOW RESOLVED - REPORTED BY SUBSCRIBER. ***
[CURRENT OR PAID SATISFACTORY ACCOUNTS]

| | | | | | | | | | | | | |
|---|---|---|---|---|---|---|---|---|---|---|---|---|
| HOME FINANCIAL | 2 | R/E | 05/90 | 400000 | 3128 | 234000 | 01/98 | 92 MONTH | 00 | 00 | 00 | M-1 |
| 24000098500012 | B | 360 | 12/97 | | | | | CURR ACCT | | | | |
| | | | | | | | | EXP01 | | | | |
| 11111111111 | | | | | | | | | | | | |
| 111111111111 | | | | | | | | | | | | |
| 1 | | | | | | | | | | | | |
| ORTEACHERFCU | 1 | R/O | 01/03 | | 0 | 19550 | 07/03 | 07 MONTH | 00 | 00 | 00 | M-1 |
| 7770801 | B | 180 | 01/03 | 20000 | 150 | | | CURR ACCT | | | | |
| | | | | | | | | TUC02 | | | | |
| 1111111 | | | | | | | | | | | | |
| 15442 DEL AMO AV | | | | | | | | | | | | |
| TUSTIN CA 92680 | | | | | | | | | | | | |
| (714-285-4000) | | | | | | | | | | | | |
| STATE BANK | 1 | CRC | 01/90 | 10000 | 255 | 8628 | 06/96 | 85 MONTH | 00 | 00 | 00 | R-1 |
| 4271008232 | B | REV | 05/96 | 9612 | | | | CURR ACCT | | | | |
| | | | | | | | | EXP01 | | | | |
| 11111111111 | | | | | | | | | | | | |
| 111111111111 | | | | | | | | | | | | |
| 1 | | | | | | | | | | | | |
| EMPLOYEES CREDIT | 2 | CRC | 02/85 | 10000 | 180 | 6029 | 01/98 | 99 MONTH | 00 | 00 | 00 | R-1 |
| 525556601 | B | REV | 01/98 | 7108 | | | | CURR ACCT | | | | |
| | | | | | | | | EXP01 | | | | |
| 11111111111 | | | | | | | | | | | | |
| 111111111111 | | | | | | | | | | | | |
| 1 | | | | | | | | | | | | |
| HEMLOCKS | 3 | ISC | 02/95 | 1000 | | 1000 | 06/96 | 17 MONTH | 00 | 00 | 00 | I-1 |
| 8285103111261 | B | 24 | 01/95 | | | | | CURR ACCT | | | | |
| | | | | | | | | EXP01 | | | | |
| XXXXXXXXXXXX | | | | | | | | | | | | |
| XXXXX | | | | | | | | | | | | |
| ORTEACHERFCU | 1 | R/O | 01/03 | | 0 | 150 | 07/03 | 07 MONTH | 00 | 00 | 00 | M-1 |
| 7770800 | B | 10 | 01/03 | 1150 | | | | CURR ACCT | | | | |
| | | | | | | | | TUC02 | | | | |
| 1111111 | | | | | | | | | | | | |
| 15442 DEL AMO AV | | | | | | | | | | | | |
| TUSTIN CA 92680 | | | | | | | | | | | | |
| (714-285-4000) | | | | | | | | | | | | |
| FST TECH CU | 1 | CRC | 12/93 | 100 | 0 | 0 | 01/00 | 07 MONTH | 00 | 00 | 00 | R-1 |
| 9995 | B | REV | 07/99 | 100 | | | | CURR ACCT | | | | |
| | | | | | | | | TUC01 | | | | |
| 1111X11 | | | | | | | | | | | | |

PO BOX 2100
BEAVERTON OR 97075
(503-644-4034)
*** THE PAYMENT PATTERN START DATE IS 12/99 ***

| | | | | | | | | | | | |
|---|---|---|---|---|---|---|---|---|---|---|---|
| BANK 1 LAF | 1 | CRC | 07/97 | 0 | 0 | 09/97 | 01 MONTH | 00 | 00 | 00 | R-1 |
| 433208000000 | B | REV | | | | | CURR ACCT | | | | |
| | | | | | | | TUC01 | | | | |
| 1 | | | | | | | | | | | |

PO BOX 8650
WILMINGTON DE 19899
*** THE PAYMENT PATTERN START DATE IS 07/97 ***

| | | | | | | | | | | | | |
|---|---|---|---|---|---|---|---|---|---|---|---|---|
| BMBY/CBUSA | 1 | CHG | 09/96 | 500 | 0 | 0 | 09/97 | 00 MONTH | 00 | 00 | 00 | R-1 |
| 6011760100500019 | B | REV | | 85 | | | | CURR ACCT | | | | |
| | | | | | | | | TUC01 | | | | |
| P.O. BOX 8337 | | | | | | | | | | | | |
| GRAY TN 37615 | | | | | | | | | | | | |
| JARED | 1 | CHG | 11/93 | | 0 | 0 | 08/96 | 00 MONTH | 00 | 00 | 00 | R-1 |
| 3000405017 | B | REV | | 0 | | | | CURR ACCT | | | | |
| | | | | | | | | TUC01 | | | | |
| 375 GHENT RD | | | | | | | | | | | | |
| AKRON OH 44333 | | | | | | | | | | | | |
| POINTWSTCU | 1 | C/C | 09/00 | 5000 | 0 | 0 | 06/02 | 11 MONTH | 00 | 00 | 00 | C-1 |
| 7620001996790010 | B | REV | | 5000 | | | | CURR ACCT | | | | |
| | | | | | | | | TUC01 | | | | |
| 1111111X111 | | | | | | | | | | | | |
| 718 NE 12TH AVENUE | | | | | | | | | | | | |
| PORTLAND OR 97232 | | | | | | | | | | | | |
| (503-546-5032) | | | | | | | | | | | | |
| METROCU | 4 | C/C | 08/98 | 2000 | 0 | 0 | 08/03 | 13 MONTH | 00 | 00 | 00 | C-1 |
| 41743600 | B | REV | | 2000 | | | | CURR ACCT | | | | |
| | | | | | | | | TUC01 | | | | |
| 111111111111 | | | | | | | | | | | | |
| 1 | | | | | | | | | | | | |
| 6611 CHICAGO AVE | | | | | | | | | | | | |
| WARREN MI 48092 | | | | | | | | | | | | |
| (586-276-3000) | | | | | | | | | | | | |
| CU OF SO CAL | 4 | AUT | 03/01 | | 0 | 0 | 11/02 | 01 MONTH | 00 | 00 | 00 | I-1 |
| 9000100001 | B | 60 | | 20000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 1 | SEC | 11/01 | | 0 | 0 | 11/02 | 01 MONTH | 00 | 00 | 00 | I-1 |
| 9000100002 | B | 36 | | 5000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 7 | SEC | 01/02 | | 0 | 0 | 11/02 | 01 MONTH | 00 | 00 | 00 | I-1 |
| 9000100003 | B | 36 | | 1000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 1 | AUT | 07/02 | | 0 | 0 | 11/02 | 01 MONTH | 00 | 00 | 00 | I-1 |
| 9000100004 | B | 1 | | 25000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 1 | AUT | 07/02 | | 0 | 0 | 11/02 | 01 MONTH | 00 | 00 | 00 | I-1 |
| 9000100005 | B | 60 | | 10000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 1 | AUT | 07/02 | | 0 | 0 | 11/02 | 01 MONTH | 00 | 00 | 00 | I-1 |
| 9000100006 | B | 48 | | 10000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 4 | AUT | 07/02 | | 0 | 0 | 11/02 | 01 MONTH | 00 | 00 | 00 | I-1 |
| 9000100007 | B | 60 | | 20000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| CU OF SO CAL | 1 | AUT | 12/01 | | 0 | 0 | 11/02 | 01 MONTH | 00 | 00 | 00 | I-1 |
| 9000102525 | B | | | 0 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| *** CLOSED *** | | | | | | | | | | | | |
| CU OF SO CAL | 1 | AUT | 02/03 | | 0 | 0 | 04/03 | 01 MONTH | 00 | 00 | 00 | I-1 |
| 9000100008 | B | 72 | | 45000 | | | | PAID ACCT | | | | |
| | | | | | | | | TUC02 | | | | |
| 1 | | | | | | | | | | | | |
| 8028 GREENLEAF AV | | | | | | | | | | | | |
| WHITTIER CA 90602 | | | | | | | | | | | | |
| (562-365-1894) | | | | | | | | | | | | |
| MERIWEST CU | 1 | CRC | 09/01 | 100 | 0 | 0 | 09/03 | 19 MONTH | 00 | 00 | 00 | R-1 |
| 412172102 | B | REV | 06/03 | 0 | | | | CURR ACCT | | | | |
| | | | | | | | | TUC02 | | | | |
| 111111111111 | | | | | | | | | | | | |
| 1111111 | | | | | | | | | | | | |

POB 530953
SAN JOSE CA 95153
(408-256-4566)
*** THE PAYMENT PATTERN START DATE IS 02/02 ***

| | | | | | | | | | | | | |
|---|---|---|---|---|---|---|---|---|---|---|---|---|
| ORANGE CO CU | 1 | CRC | 05/02 | 11000 | 0 | 0 | 09/03 | 16 MONTH | 00 | 00 | 00 | R-1 |
| 4559740090090018 | B | REV | | 0 | | | | CURR ACCT | | | | |
| | | | | | | | | TUC02 | | | | |
| 11111111 | | | | | | | | | | | | |
| POB 11777 | | | | | | | | | | | | |
| SANTA ANA CA 92711 | | | | | | | | | | | | |
| (714-755-5900) | | | | | | | | | | | | |
| HAROLDS FINL | 1 | CHG | 04/99 | | 0 | 0 | 09/03 | 27 MONTH | 00 | 00 | 00 | R-1 |
| 3059100568 | B | REV | | 0 | | | | CURR ACCT | | | | |
| | | | | | | | | TUC02 | | | | |
| 111111111111 | | | | | | | | | | | | |
| 111111111111 | | | | | | | | | | | | |
| 765 ASP | | | | | | | | | | | | |
| NORMAN OK 73069 | | | | | | | | | | | | |
| (405-329-4045) | | | | | | | | | | | | |
| MEIER&FRANK | 1 | CHG | 11/99 | 200 | 0 | 0 | 09/03 | 44 MONTH | 00 | 00 | 00 | R-1 |
| 189 | B | REV | | 0 | | | | CURR ACCT | | | | |
| | | | | | | | | TUC02 | | | | |
| 111111111111 | | | | | | | | | | | | |
| 111111111111 | | | | | | | | | | | | |
| P.O. BOX 60593 | | | | | | | | | | | | |
| PHOENIX AZ 85082 | | | | | | | | | | | | |
| FIRST FUTURE | 1 | AUT | 01/00 | | 0 | 0 | 08/01 | 19 MONTH | 00 | 00 | 00 | I-1 |
| 504370801 | B | 60 | | 0 | | | | PAID ACCT | | | | |
| | | | | | | | | TUC02 | | | | |
| 11X111111111 | | | | | | | | | | | | |
| 1111111 | | | | | | | | | | | | |
| PO BOX 509074 | | | | | | | | | | | | |
| SAN DIEGO CA 92150 | | | | | | | | | | | | |
| *** CLOSED *** | | | | | | | | | | | | |
| MERIWEST CU | 4 | CLS | 12/00 | 18200 | 0 | 0 | 02/01 | 03 MONTH | 00 | 00 | 00 | C-1 |
| 96946180002 | B | REV | | 0 | | | | CURR ACCT | | | | |
| | | | | | | | | TUC02 | | | | |
| XX1 | | | | | | | | | | | | |

5615 CHESBRO AVE
SAN JOSE CA 95123
(408-256-4566)
*** ACCOUNT CLOSED BY CONSUMER ***

| | | | | | | | | | | | | |
|---|---|---|---|---|---|---|---|---|---|---|---|---|
| ORTEACHERFCU | 1 | R/O | 11/01 | | 0 | 0 | 06/02 | 01 MONTH | 00 | 00 | 00 | M-1 |
| 990804 | B | 10 | | 0 | | | | PAID ACCT | | | | |
| | | | | | | | | TUC02 | | | | |
| 1 | | | | | | | | | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 2 | R/O | 11/01 | | 0 | 0 | 06/02 | 01 MONTH | 00 | 00 | 00 | M-1 |
| 990805 | B | 180 | | 10000 | | | | PAID ACCT | | | | |
| | | | | | | | | TUC02 | | | | |
| 1 | | | | | | | | | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| CYPRUS CU | 1 | CRC | 03/02 | | 0 | 0 | 07/03 | 14 MONTH | 00 | 00 | 00 | R-1 |
| 1104416300 | B | REV | 07/03 | 5 | | | | PAID ACCT | | | | |
| | | | | | | | | TUC02 | | | | |
| XXXXXXXXXXXX | | | | | | | | | | | | |
| X1 | | | | | | | | | | | | |
| 3505 SOUTH 8400 WE | | | | | | | | | | | | |
| MAGNA UT 84044 | | | | | | | | | | | | |
| *** CLOSED*** | | | | | | | | | | | | |
| TRAVEL CHARGE US | 1 | CRC | 03/95 | 4000 | | 0 | 12/97 | 34 MONTH | 00 | 00 | 00 | R-1 |
| 4271008232 | B | REV | 12/97 | 3612 | | | | PAID SATIS | | | | |
| | | | | | | | | EXP01 | | | | |
| 11111111111 | | | | | | | | | | | | |
| 111111111111 | | | | | | | | | | | | |
| 1 | | | | | | | | | | | | |
| ORTEACHERFCU | 1 | AUT | 01/03 | | 0 | 0 | 04/03 | 03 MONTH | 00 | 00 | 00 | I-1 |
| 7770802 | B | 60 | 04/03 | 15000 | | | | PAID ACCT | | | | |
| | | | | | | | | TUC02 | | | | |
| X11 | | | | | | | | | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ISLAND SAVINGS | 2 | CRC | 05/96 | 7000 | | 0 | 10/97 | 18 MONTH | 00 | 00 | 00 | R-1 |
| 405855254820 | B | REV | 10/97 | 5700 | | | | CURR ACCT | | | | |
| | | | | | | | | EXP01 | | | | |
| -11111111111 | | | | | | | | | | | | |
| 111111 | | | | | | | | | | | | |

*** CREDIT LINE CLOSED - CONSUMER'S REQUEST - REPORTED BY SUBSCRIBER. ***

| | | | | | | | | | | | | |
|---|---|---|---|---|---|---|---|---|---|---|---|---|
| STPC/CBUSA | 1 | CCP | 06/02 | 5000 | 0 | 0 | 05/03 | 12 MONTH | 00 | 00 | 00 | R-1 |
| 7972130103240051 | B | REV | | 0 | | | | CURR ACCT | | | | |
| | | | | | | | | TUC02 | | | | |
| 111111111111 | | | | | | | | | | | | |
| 2195 N 1200 W. | | | | | | | | | | | | |
| LAYTON UT 84041 | | | | | | | | | | | | |
| TOOELE FCU | 1 | UNS | 10/98 | | 0 | 0 | 03/99 | 01 MONTH | 00 | 00 | 00 | I-1 |
| 401070000 | B | | | 0 | | | | PAID ACCT | | | | |
| | | | | | | | | TUC02 | | | | |
| 1 | | | | | | | | | | | | |
| POB T | | | | | | | | | | | | |
| TOOELE UT 84074 | | | | | | | | | | | | |
| *** CLOSED *** | | | | | | | | | | | | |
| ULTR/CBUSA | 1 | CCP | 06/98 | 500 | 0 | 0 | 01/03 | 26 MONTH | 00 | 00 | 00 | R-1 |
| 6011652202000016 | B | REV | | 0 | | | | CURR ACCT | | | | |
| | | | | | | | | TUC02 | | | | |
| 111111111111 | | | | | | | | | | | | |
| 111111111111 | | | | | | | | | | | | |
| PO BOX 8189 | | | | | | | | | | | | |
| GRAY TN 37615 | | | | | | | | | | | | |
| ULTR/CBUSA | 1 | CCP | 06/98 | 1000 | 0 | 0 | 01/03 | 26 MONTH | 00 | 00 | 00 | R-1 |
| 6011652100500018 | B | REV | | 0 | | | | CURR ACCT | | | | |
| | | | | | | | | TUC02 | | | | |
| 111111111111 | | | | | | | | | | | | |
| 111111111111 | | | | | | | | | | | | |
| PO BOX 8189 | | | | | | | | | | | | |
| GRAY TN 37615 | | | | | | | | | | | | |
| PEEBLES | 1 | CHG | 10/98 | | 0 | 0 | 07/02 | 02 MONTH | 00 | 00 | 00 | R-1 |
| 16132219 | B | REV | | 200 | | | | CURR ACCT | | | | |
| | | | | | | | | TUC02 | | | | |
| 11 | | | | | | | | | | | | |
| 1 PEEBLES ST | | | | | | | | | | | | |
| SOUTH HILL VA 23970 | | | | | | | | | | | | |
| (804-447-5200) | | | | | | | | | | | | |
| NWC COMM FCU | 1 | AUT | 11/99 | | 0 | 0 | 01/00 | 02 MONTH | 00 | 00 | 00 | I-1 |
| 12708932 | B | 48 | 01/00 | 10000 | | | | PAID ACCT | | | | |
| | | | | | | | | TUC02 | | | | |
| X1 | | | | | | | | | | | | |

701 S CHINA LAKE
RIDGECREST CA 93555
(619-371-7050)
*** CLOSED ***

| | | | | | | | | | | | | |
|---|---|---|---|---|---|---|---|---|---|---|---|---|
| FIRST FUTURE | 1 | R/E | 03/99 | | 0 | 0 | 11/99 | 02 MONTH | 00 | 00 | 00 | M-1 |
| 504370809 | B | 120 | | 0 | 50 | | | PAID ACCT | | | | |
| | | | | | | | | TUC02 | | | | |
| 11 | | | | | | | | | | | | |
| PO BOX 509074 | | | | | | | | | | | | |
| SAN DIEGO CA 92150 | | | | | | | | | | | | |
| FIRST FUTURE | 1 | C/C | 01/99 | | 0 | 0 | 11/99 | 02 MONTH | 00 | 00 | 00 | C-1 |
| 504370807 | B | REV | | 0 | | | | CURR ACCT | | | | |
| | | | | | | | | TUC02 | | | | |
| 11 | | | | | | | | | | | | |
| PO BOX 509074 | | | | | | | | | | | | |
| SAN DIEGO CA 92150 | | | | | | | | | | | | |
| FARMERS INS | 1 | CRC | 01/02 | 1000 | 0 | 0 | 03/03 | 01 MONTH | 00 | 00 | 00 | R-1 |
| 984337400 | B | REV | 02/02 | 1000 | | | | CURR ACCT | | | | |
| | | | | | | | | TUC03 | | | | |
| 1 | | | | | | | | | | | | |

4680 WILSHIRE BLVD
LOS ANGELES CA 90010
*** THE PAYMENT PATTERN START DATE IS 02/02 ***

| | | | | | | | | | | | | |
|---|---|---|---|---|---|---|---|---|---|---|---|---|
| FARMERS INS | 1 | CRC | 06/01 | 25000 | 0 | 0 | 03/03 | 06 MONTH | 00 | 00 | 00 | R-1 |
| 984335100 | B | REV | 11/02 | 25000 | | | | CURR ACCT | | | | |
| | | | | | | | | TUC03 | | | | |
| 11XXX1 | | | | | | | | | | | | |

4680 WILSHIRE BLVD
LOS ANGELES CA 90010
*** THE PAYMENT PATTERN START DATE IS 10/02 ***

| | | | | | | | | | | | | |
|---|---|---|---|---|---|---|---|---|---|---|---|---|
| FARMERS INS | 2 | CRC | 10/00 | 15500 | 0 | 0 | 03/03 | 05 MONTH | 00 | 00 | 00 | R-1 |
| 984335000 | B | REV | 09/02 | 15500 | | | | CURR ACCT | | | | |
| | | | | | | | | TUC03 | | | | |
| 1XXX1 | | | | | | | | | | | | |

4680 WILSHIRE BLVD
LOS ANGELES CA 90010
*** THE PAYMENT PATTERN START DATE IS 09/02 ***

| | | | | | | | | | | | | |
|---|---|---|---|---|---|---|---|---|---|---|---|---|
| FARMERS INS | 1 | C/C | 05/01 | 5000 | 0 | 0 | 03/03 | 11 MONTH | 00 | 00 | 00 | R-1 |
| 984331700 | B | REV | 12/02 | 5000 | | | | CURR ACCT | | | | |
| | | | | | | | | TUC03 | | | | |
| 11XXXXXXXX1 | | | | | | | | | | | | |

4680 WILSHIRE BLVD
LOS ANGELES CA 90010
*** THE PAYMENT PATTERN START DATE IS 12/02 ***

| | | | | | | | | | | | | |
|---|---|---|---|---|---|---|---|---|---|---|---|---|
| BANK AMERICA | 2 | R/E | 11/88 | | 0 | | 05/94 | 00 MONTH | 00 | 00 | 00 | M-1 |
| 1735943663 | B | 360 | | 144000 | 1389 | | | CURR ACCT | | | | |
| | | | | | | | | TUC03 | | | | |
| 479 CROSSPOINT PKW | | | | | | | | | | | | |
| GETZVILLE NY 14068 | | | | | | | | | | | | |
| [MISCELLANEOUS] | | | | | | | | | | | | |
| CANANDNB | 1 | AUT | 08/99 | | 0 | 0 | 08/99 | 00 MONTH | 00 | 00 | 00 | I-0 |
| 1100446205 | B | 60 | 08/99 | 0 | | | | UNRATED | | | | |
| | | | | | | | | TUC01 | | | | |

72 S MAIN ST
CANANDAIGUA NY 14424
(716-394-4260)
*** CLOSED ***

| | | | | | | | | | | | | |
|---|---|---|---|---|---|---|---|---|---|---|---|---|
| FIN PART CU | 1 | AUT | 06/96 | | 0 | 0 | 10/97 | 00 MONTH | 00 | 00 | 00 | I-0 |
| 22721 | B | 35 | | 20000 | | | | UNRATED | | | | |
| | | | | | | | | TUC01 | | | | |
| 7800 E IMPERIAL HY | | | | | | | | | | | | |
| DOWNEY CA 90241 | | | | | | | | | | | | |
| (562-923-0311) | | | | | | | | | | | | |
| *** CLOSED *** | | | | | | | | | | | | |
| ORTEACHERFCU | 1 | AUT | 09/97 | | 0 | 0 | 09/97 | 00 MONTH | 00 | 00 | 00 | I-0 |
| 660800 | B | 48 | | 28000 | | | | UNRATED | | | | |
| | | | | | | | | TUC01 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| DMGT/CBUSA | 1 | CHG | 08/95 | 300 | 0 | 0 | 09/97 | 00 MONTH | 00 | 00 | 00 | R-0 |
| 6011655500400010 | B | REV | | 0 | | | | UNRATED | | | | |
| | | | | | | | | TUC01 | | | | |
| POB 8637 | | | | | | | | | | | | |
| GRAY TN 37615 | | | | | | | | | | | | |
| ORTEACHERFCU | 1 | UNS | 06/95 | | 0 | 0 | 06/95 | 00 MONTH | 00 | 00 | 00 | I-0 |
| 9990800 | B | 24 | | 1000 | | | | UNRATED | | | | |
| | | | | | | | | TUC01 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| S&T BANK | 1 | UNS | 02/00 | | 0 | 0 | 04/00 | 02 MONTH | 00 | 00 | 00 | I-0 |
| 100040550400001 | B | 36 | | 625 | | | | UNRATED | | | | |
| | | | | | | | | TUC03 | | | | |
| 800 PHILADELPHIA | | | | | | | | | | | | |
| INDIANA PA 15701 | | | | | | | | | | | | |
| (724-349-2900) | | | | | | | | | | | | |
| *** CLOSED *** | | | | | | | | | | | | |
| CU OF SO CAL | 1 | AUT | 05/03 | | 0 | 0 | 06/03 | 01 MONTH | 00 | 00 | 00 | I-0 |
| 9000100009 | B | 72 | 05/03 | 85000 | | | | UNRATED | | | | |
| | | | | | | | | TUC02 | | | | |
| 8028 GREENLEAF AV | | | | | | | | | | | | |
| WHITTIER CA 90602 | | | | | | | | | | | | |
| (562-365-1894) | | | | | | | | | | | | |
| *** CLOSED *** | | | | | | | | | | | | |
| MERIWEST CU | 1 | H/E | 12/02 | | 0 | 0 | 12/02 | 01 MONTH | 00 | 00 | 00 | M-0 |
| 96883480002 | B | 10 | 12/02 | 10300 | | | | UNRATED | | | | |
| | | | | | | | | TUC02 | | | | |

5615 CHESBRO AVE
SAN JOSE CA 95123
(408-256-4566)
*** ACCOUNT CLOSED BY CONSUMER ***

| | | | | | | | | | | | | |
|---|---|---|---|---|---|---|---|---|---|---|---|---|
| MERIWEST CU | 1 | R/O | 12/02 | | 0 | 0 | 12/02 | 01 MONTH | 00 | 00 | 00 | M-0 |
| 96883480003 | B | 180 | 12/02 | 25000 | | | | UNRATED | | | | |
| | | | | | | | | TUC02 | | | | |
| 5615 CHESBRO AVE | | | | | | | | | | | | |
| SAN JOSE CA 95123 | | | | | | | | | | | | |
| (408-256-4566) | | | | | | | | | | | | |
| *** CLOSED *** | | | | | | | | | | | | |
| ORTEACHERFCU | 1 | UNS | 09/01 | | 0 | 0 | 09/01 | 01 MONTH | 00 | 00 | 00 | I-0 |
| 990803 | B | 36 | | 1500 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| CAMBRDGP SVG | 1 | C/C | 05/99 | | 0 | 0 | 01/03 | 01 MONTH | 00 | 00 | 00 | C-0 |
| 50000000001 | B | REV | 07/01 | 0 | | | | UNRATED | | | | |
| | | | | | | | | TUC02 | | | | |

1374 MASSACHUSETTS
CAMBRIDGE MA 02139
(617-864-8700)
*** TRANSFER ***

| | | | | | | | | | | | | |
|---|---|---|---|---|---|---|---|---|---|---|---|---|
| ORTEACHERFCU | 1 | UNS | 05/02 | | 0 | 0 | 05/02 | 01 MONTH | 00 | 00 | 00 | I-0 |
| 60800 | B | 36 | | 3000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 05/02 | | 0 | 0 | 05/02 | 01 MONTH | 00 | 00 | 00 | I-0 |
| 660900 | B | 180 | | 10000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | SEC | 05/03 | | 0 | 0 | 05/03 | 01 MONTH | 00 | 00 | 00 | I-0 |
| 7770803 | B | 1 | | 10 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | R/O | 06/03 | | 0 | 0 | 06/03 | 01 MONTH | 00 | 00 | 00 | M-0 |
| 7770804 | B | 10 | | 0 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 07/03 | | 0 | 0 | 07/03 | 01 MONTH | 00 | 00 | 00 | I-0 |
| 7770807 | B | 36 | | 1000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| NWC COMM FCU | 1 | UNS | 04/03 | | 0 | 0 | 04/03 | 01 MONTH | 00 | 00 | 00 | I-0 |
| 12708901 | B | | 04/03 | 500 | | | | UNRATED | | | | |
| | | | | | | | | TUC02 | | | | |

701 S CHINA LAKE
RIDGECREST CA 93555
(619-371-7050)
*** CLOSED ***

| | | | | | | | | | | | | |
|---|---|---|---|---|---|---|---|---|---|---|---|---|
| NWC COMM FCU | 1 | UNS | 04/03 | | 0 | 0 | 05/03 | 01 MONTH | 00 | 00 | 00 | I-0 |
| 12708903 | B | 11 | 04/03 | 500 | | | | UNRATED | | | | |
| | | | | | | | | TUC02 | | | | |

701 S CHINA LAKE
RIDGECREST CA 93555
(619-371-7050)
*** CLOSED ***

| | | | | | | | | | | | | |
|---|---|---|---|---|---|---|---|---|---|---|---|---|
| EBTEL FCU | 1 | C/C | 12/00 | | 0 | 0 | 02/03 | 01 MONTH | 00 | 0 | 00 | C-0 |
| 766092201 | B | REV | 12/00 | 10000 | | | | UNRATED | | | | |
| | | | | | | | | TUC02 | | | | |

3120 CROW CANYON
SAN RAMON CA 94583
(510-734-8080)
*** CLOSED ***

| | | | | | | | | | | | | |
|---|---|---|---|---|---|---|---|---|---|---|---|---|
| EBTEL FCU | 1 | AUT | 09/01 | | 0 | 0 | 02/03 | 01 MONTH | 00 | 00 | 00 | I-0 |
| 766096700 | B | 12 | 09/01 | 500 | | | | UNRATED | | | | |
| | | | | | | | | TUC02 | | | | |

3120 CROW CANYON
SAN RAMON CA 94583
(510-734-8080)
*** CLOSED ***

| | | | | | | | | | | | | |
|---|---|---|---|---|---|---|---|---|---|---|---|---|
| ORTEACHERFCU | 1 | AUT | 04/01 | | 0 | 0 | 04/01 | 01 MONTH | 00 | 00 | 00 | I-0 |
| 990802 | B | 60 | | 15000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 2 | AUT | 03/01 | | 0 | 0 | 03/01 | 00 MONTH | 00 | 00 | 00 | I-0 |
| 880808 | B | 60 | | 10000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORANGE CO CU | 1 | CRC | 11/01 | 5000 | 0 | 0 | 11/01 | 00 MONTH | 00 | 00 | 00 | R-0 |
| 4209730010140583 | B | REV | | 0 | | | | UNRATED | | | | |
| | | | | | | | | TUC02 | | | | |

POB 11777
SANTA ANA CA 92711
(714-755-5900)
*** ACCOUNT CLOSED BY CONSUMER ***

| | | | | | | | | | | | | |
|---|---|---|---|---|---|---|---|---|---|---|---|---|
| ORTEACHERFCU | 1 | UNS | 02/01 | | 0 | 0 | 02/01 | 00 MONTH | 00 | 00 | 00 | I-0 |
| 880807 | B | 48 | | 10000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | UNS | 02/00 | | 0 | 0 | 03/00 | 01 MONTH | 00 | 00 | 00 | I-0 |
| 660808 | B | 2 | | 500 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 10/00 | | 0 | 0 | 10/00 | 00 MONTH | 00 | 00 | 00 | I-0 |
| 8880804 | B | 36 | | 2000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 2 | REC | 01/00 | | 0 | 0 | 07/00 | 01 MONTH | 00 | 00 | 00 | I-0 |
| 770801 | B | 36 | | 12000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 02/00 | | 0 | 0 | 02/00 | 00 MONTH | 00 | 00 | 00 | I-0 |
| 88880808 | B | 60 | | 12000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 02/00 | | 0 | 0 | 03/00 | 01 MONTH | 00 | 00 | 00 | I-0 |
| 88880809 | B | 60 | | 5000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | UNS | 10/00 | | 0 | 0 | 10/00 | 00 MONTH | 00 | 00 | 00 | I-0 |
| 8880803 | B | 12 | | 1200 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | AUT | 09/00 | | 0 | 0 | 09/00 | 00 MONTH | 00 | 00 | 00 | I-0 |
| 8880802 | B | 36 | | 2000 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| ORTEACHERFCU | 1 | UNS | 09/99 | | 0 | 0 | 09/99 | 00 MONTH | 00 | 00 | 00 | I-0 |
| 8880800 | B | 24 | | 500 | | | | UNRATED | | | | |
| | | | | | | | | TUC02 | | | | |
| 15442 DEL AMO AV | | | | | | | | | | | | |
| TUSTIN CA 92680 | | | | | | | | | | | | |
| (714-285-4000) | | | | | | | | | | | | |
| *** CLOSED *** | | | | | | | | | | | | |
| NWC COMM FCU | 1 | UNS | 01/02 | | 0 | 0 | 02/02 | 01 MONTH | 00 | 00 | 00 | I-0 |
| 12708919 | B | 24 | 01/02 | 600 | | | | UNRATED | | | | |
| | | | | | | | | TUC02 | | | | |

701 S CHINA LAKE
RIDGECREST CA 93555
(619-371-7050)
*** CLOSED ***

| | | | | | | | | | | | | |
|---|---|---|---|---|---|---|---|---|---|---|---|---|
| NWC COMM FCU | 1 | UNS | 01/02 | | 0 | 0 | 02/02 | 01 MONTH | 00 | 00 | 00 | I-0 |
| 12708918 | B | 12 | 01/02 | 500 | | | | UNRATED | | | | |
| | | | | | | | | TUC02 | | | | |

701 S CHINA LAKE
RIDGECREST CA 93555
(619-371-7050)
*** CLOSED ***

| | | | | | | | | | | | | |
|---|---|---|---|---|---|---|---|---|---|---|---|---|
| FARMERS INS | 1 | UNS | 11/02 | | 0 | 0 | 12/02 | 01 MONTH | 00 | 00 | 00 | I-0 |
| 984330102 | B | 12 | 11/02 | 2000 | | | | UNRATED | | | | |
| | | | | | | | | TUC03 | | | | |

4680 WILSHIRE BLVD
LOS ANGELES CA 90010
*** CLOSED ***

| | | | | | | | | | | | | |
|---|---|---|---|---|---|---|---|---|---|---|---|---|
| FARMERS INS | 1 | AUT | 03/02 | | 0 | 0 | 07/02 | 01 MONTH | 00 | 00 | 00 | I-0 |
| 984335700 | B | 60 | 05/02 | 5000 | | | | UNRATED | | | | |
| | | | | | | | | TUC03 | | | | |

4680 WILSHIRE BLVD
LOS ANGELES CA 90010
*** CLOSED ***

| | | | | | | | | | | | | |
|---|---|---|---|---|---|---|---|---|---|---|---|---|
| S&T BANK | 1 | UNS | 02/00 | | 0 | 0 | 04/00 | 02 MONTH | 00 | 00 | 00 | I-0 |
| 100040550400003 | B | 24 | | 725 | | | | UNRATED | | | | |
| | | | | | | | | TUC03 | | | | |
| 800 PHILADELPHIA | | | | | | | | | | | | |
| INDIANA PA 15701 | | | | | | | | | | | | |
| (724-349-2900) | | | | | | | | | | | | |
| *** CLOSED *** | | | | | | | | | | | | |

| | | |
|---|---|---|
| [INQUIRIES] | | |
| Oct. 09, 2003 | TESTFNCSWEBSOLUTI/FNCS | TUC01 |
| Oct. 08, 2003 | NTN | TUC02 |
| | 525 SW FIRST | |
| | LAKE OSWEGO OR 97035 | |
| | (800-228-0989) | |
| Oct. 08, 2003 | INFRM RESRCH | TUC02 |
| | PO BOX 2379 | |
| | GARDEN GROVE CA 92842 | |
| | (714-638-2855) | |
| Oct. 08, 2003 | COLUMBIANATIONALBE/FA-NY | TUC01 |
| | 333 EARLE OVINGTON | |
| | UNIONDALE NY 11553 | |
| | (516-832-3400) | |
| Oct. 08, 2003 | APPLE FCU | TUC01 |
| | 4029 RIDGETOP RD. | |
| | FAIRFAX VA 22030 | |
| | (703-323-0246) | |
| Oct. 08, 2003 | 376HOMESTEADFUNDI/CBCMTG | TUC01 |
| | 170 E TOWER ST | |
| | COLOMBUS OH 43215 | |
| | (614-222-4319) | |
| Oct. 08, 2003 | HOGENE/NTN | TUC01 |
| | 525 SW FIRST | |
| | LAKE OSWEGO OR 97035 | |
| | (800-228-0989) | |
| Oct. 08, 2003 | PERCENTAGELEN/NCOCREDITS | TUC01 |
| | 101 OVERLAND | |
| | NORTH AURORA IL 60542 | |
| | (630-897-6700) | |
| Oct. 08, 2003 | EDUCATORS | TUC01 |
| | PO BOX 10407 | |
| | BIRMINGHAM AL 35202 | |
| | (205-581-8800) | |
| Oct. 08, 2003 | KOLB PROPERT | TUC01 |
| | 1703 PEARL ST | |
| | WAUKESHA WI 53186 | |
| Oct. 07, 2003 | NAVISTAR FIN | TUC02 |
| | PO BOX 4038 | |
| | SCHAUMBURG IL 60168 | |
| | (847-517-3500) | |
| Oct. 07, 2003 | ST ANNE'S CU | TUC01 |
| | POB O | |
| | FALL RIVER MA 02724 | |
| | (508-676-8581) | |
| Oct. 07, 2003 | COLUMBIANATIONAL-/FA-NY | TUC01 |
| | 333 EARLE OVINGTON | |
| | UNIONDALE NY 11553 | |
| | (516-832-3400) | |
| Oct. 07, 2003 | VISIONMORTGAGE/CDS | TUC01 |
| | 2500 MAITLAND CENT | |
| | MAITLAND FL 32751 | |
| | (818-881-5398) | |
| Oct. 07, 2003 | NETWORKCREDIT/NETWORKCRS | TUC01 |
| | 1463 OAKFIELD DR | |
| | BRANDON FL 33511 | |
| | (813-685-5678) | |
| Oct. 07, 2003 | PERCENTAGELEN/NCOCREDITS | TUC01 |
| | 101 OVERLAND | |
| | NORTH AURORA IL 60542 | |
| | (800-925-6691) | |
| Oct. 07, 2003 | AAACreditBureau/AAACB | TUC01 |
| | 15300 DEVONSHIRE | |
| | MISSION HILLS CA 91345 | |
| | (818-894-7501) | |
| Oct. 06, 2003 | UNIONMITSUBI/UNIONMITSUB | TUC02 |
| | 3267 W OLYMPIC BLV | |
| | LOS ANGELES CA 90006 | |
| | (323-735-5555) | |
| Oct. 06, 2003 | CONSCRDTBUDGET/CBASSOFIL | TUC02 |
| | IV EXECUTIVE CAMPU | |
| | CHERRY HILL NJ 08002 | |
| | (609-795-3211) | |
| Oct. 06, 2003 | TESTACCOUNT/ADVANTAGECR | TUC01 |
| | 15 W STRONG STREET | |
| | PENSACOLA FL 32501 | |
| | (850-470-9336) | |
| Oct. 06, 2003 | COLUMBIANATIONAL-/FA-NY | TUC01 |
| | 333 EARLE OVINGTON | |
| | UNIONDALE NY 11553 | |
| | (516-832-3400) | |
| Oct. 06, 2003 | PERCENTAGECORPORAT/INFO1 | TUC01 |
| | 23622 CALABASAS RD | |
| | CALABASAS CA 91302 | |
| | (800-487-4887) | |
| Oct. 06, 2003 | SUNRISECOMMUN/COMMCOCRDT | TUC01 |
| | 1156 N TUSTIN | |
| | ORANGE CA 92867 | |
| | (714-288-3535) | |
| Oct. 06, 2003 | INNOVATIVESOFTW/NOAMERCR | TUC01 |
| | 270 STORKE RD | |
| | GOLETA CA 93117 | |
| | (805-563-8822) | |
| Oct. 06, 2003 | LOANCOMANDERMORT/FDNGSTE | TUC01 |
| | 4520 EXECUTIVE DRI | |
| | SAN DIEGO CA 92121 | |
| | (877-493-1938) | |
| Oct. 03, 2003 | NASSAU ED | TUC02 |
| | 264 E MERNICK RD | |
| | VALLEY STREAM NY 11580 | |
| | (576-561-0030) | |
| Oct. 03, 2003 | COMMCO CRDT | TUC02 |
| | 1156 N TUSTIN | |
| | ORANGE CA 92867 | |
| | (714-288-3535) | |
| Oct. 03, 2003 | THEMORTGAGEHOUSE/CCIS | TUC01 |
| | 5405 STOCKDALE HWY | |
| | BAKERSFIELD CA 93309 | |
| | (661-398-4700) | |
| Oct. 03, 2003 | TESTACCOUNT/ADVANTAGECR | TUC01 |
| | 15 W STRONG STREET | |
| | PENSACOLA FL 32501 | |
| | (850-470-9336) | |
| Oct. 03, 2003 | MORTGAGESUNLI/GARDENCITY | TUC01 |
| | 1135 COLLEGE DR | |
| | GARDEN CITY KS 67846 | |
| | (620-276-7631) | |
| Oct. 03, 2003 | CTXMORTGAGECOM/CBASSOFIL | TUC01 |
| | IV EXECUTIVE CAMPU | |
| | CHERRY HILL NJ 08002 | |
| | (609-795-3211) | |
| Oct. 03, 2003 | PERCENTAGELEN/NCOCREDITS | TUC01 |
| | 101 OVERLAND | |
| | NORTH AURORA IL 60542 | |
| | (630-897-6700) | |
| Oct. 03, 2003 | NTNHQTEST/NTN | TUC01 |
| | 525 SW FIRST #105 | |
| | SHERWOOD OR 97140 | |
| | (503-635-1118) | |
| Oct. 03, 2003 | 1ST NATL BK | TUC01 |
| | 109 SOUTH WALNUT S | |
| | LA CRESCENT MN 55947 | |
| | (507-895-5600) | |
| Oct. 03, 2003 | DEMOCUSTOMER/DATAFAXCRDT | TUC01 |
| | IV EXECUTIVE CAMPU | |
| | CHERRY HILL NJ 08002 | |
| | (609-795-2221) | |
| Oct. 03, 2003 | ST ANNE'S CU | TUC01 |
| | POB O | |
| | FALL RIVER MA 02724 | |
| | (508-676-8581) | |
| Oct. 03, 2003 | AMERICANHOMELOAN/FDNGSTE | TUC01 |
| | 4520 EXECUTIVE DRI | |
| | SAN DIEGO CA 92121 | |
| | (877-493-1938) | |
| Oct. 02, 2003 | MTG CRT SRV | TUC01 |
| | 225 S EAST ST | |
| | INDIANAPOLIS IN 46202 | |
| | (317-264-3800) | |
| Oct. 02, 2003 | ST ANNE'S CU | TUC01 |
| | POB O | |
| | FALL RIVER MA 02724 | |
| | (508-676-8581) | |
| Oct. 02, 2003 | FAIRWAYMORTGAGECOR/MCS | TUC01 |
| | 225 S. EAST STREET | |
| | INDIANAPOLIS IN 46202 | |
| | (317-264-3800) | |
| Oct. 02, 2003 | DIVERSIFIEDF/CDS-MPCDEPT | TUC01 |
| | 2500 MAITLAND CENT | |
| | MAITLAND FL 32751 | |
| | (407-632-3365) | |
| Oct. 01, 2003 | AAA CB | TUC02 |
| | 15300 DEVONSHIRE | |
| | MISSION HILLS CA 91345 | |
| | (818-894-7501) | |
| Oct. 01, 2003 | AAACreditBureau/AAACB | TUC01 |
| | 15300 DEVONSHIRE | |
| | MISSION HILLS CA 91345 | |
| | (818-894-7501) | |
| Oct. 01, 2003 | INNOVATIVESOFT/TUMRTGDPT | TUC01 |
| | 6111 OAK TREE BLVD | |
| | INDEPENDENCE OH 44131 | |
| | (216-643-3400) | |
| Oct. 01, 2003 | ARLINGTONCAPIT/CBASSOFIL | TUC01 |
| | IV EXECUTIVE CAMPU | |
| | CHERRY HILL NJ 08002 | |
| | (609-795-3211) | |
| Oct. 01, 2003 | MERITLENDINGCOM/FDNGSTE | TUC01 |
| | 4520 EXECUTIVE DRI | |
| | SAN DIEGO CA 92121 | |
| | (877-493-1938) | |
| Oct. 01, 2003 | MONEYLINELEND/COMMCOCRDT | TUC01 |
| | 1156 N TUSTIN | |
| | ORANGE CA 92867 | |
| | (714-288-3535) | |
| Oct. 01, 2003 | COLUMBIANATIONAL/R/FA-NY | TUC01 |
| | 333 EARLE OVINGTON | |
| | UNIONDALE NY 11553 | |
| | (516-832-3400) | |
| Oct. 01, 2003 | CREDIT DATA | TUC01 |
| | 1451 HARTMAN | |
| | BOISE ID 83704 | |
| | (208-322-3000) | |
| Oct. 01, 2003 | CMMC-HOMELOANSGRP-/FAC | TUC01 |
| | 12395 FIRST AMERIC | |
| | POWAY CA 92064 | |
| | (800-255-0792) | |
| Sep. 30, 2003 | NTN | TUC02 |
| | 8366 SIX FORKS RD | |
| | RALEIGH NC 27615 | |
| | (919-844-8950) | |
| Sep. 30, 2003 | NCO CREDIT S | TUC02 |
| | 101 OVERLAND | |
| | NORTH AURORA IL 60542 | |
| | (800-925-6691) | |
| Sep. 30, 2003 | CHARTERFUNDIN/1STMAGNUSF | TUC02 |
| | 5285 EAST WILLIAMS | |
| | TUCSON AZ 85711 | |
| | (520-745-5100) | |
| Sep. 30, 2003 | STURDYSAVINGSB/CBASSOFIL | TUC01 |
| | IV EXECUTIVE CAMPU | |
| | CHERRY HILL NJ 08002 | |
| | (609-795-3211) | |
| Sep. 30, 2003 | EZREALTY/COMMCOCRDT | TUC01 |
| | 1156 N TUSTIN | |
| | ORANGE CA 92867 | |
| | (714-288-3535) | |
| Sep. 30, 2003 | SCANDIANAPARTMENTS/NTN | TUC01 |
| | 8366 SIX FORKS RD | |
| | RALEIGH NC 27615 | |
| | (919-844-8950) | |
| Sep. 30, 2003 | GVCMORTGAGEINC/MTGCRTSRV | TUC01 |
| | 225 S EAST ST | |
| | INDIANAPOLIS IN 46202 | |
| | (317-264-3800) | |
| Sep. 30, 2003 | FREEDOMPROPERTIE/FDNGSTE | TUC01 |
| | 4520 EXECUTIVE DRI | |
| | SAN DIEGO CA 92121 | |
| | (877-493-1938) | |
| Sep. 30, 2003 | RONSAXONFORDINC/CREDCO | TUC01 |
| | 5626 RUFFIN ROAD | |
| | SAN DIEGO CA 92123 | |
| Sep. 30, 2003 | HOLL. JEWL. | TUC01 |
| | 2848 S 6TH ST | |
| | KLAMATH FALLS OR 97603 | |
| | (541-884-9033) | |
| Sep. 29, 2003 | 376CENTRALCREDITB/CBCMTG | TUC01 |
| | 170 E TOWER ST | |
| | COLOMBUS OH 43215 | |
| | (614-222-4319) | |
| Sep. 29, 2003 | THREERIVERSFED/MTGCRTSRV | TUC01 |
| | 225 S EAST ST | |
| | INDIANAPOLIS IN 46202 | |
| | (317-264-3800) | |
| Sep. 29, 2003 | 001FISERVEEASY/CBCCOMACS | TUC01 |
| | CR BUR COLUMBUS | |
| | COLUMBUS OH 43215 | |
| | (614-538-6045) | |
| Sep. 29, 2003 | MONEYLINELEND/COMMCOCRDT | TUC01 |
| | 1156 N TUSTIN | |
| | ORANGE CA 92867 | |
| | (714-288-3535) | |
| Sep. 29, 2003 | GATEWAYFINANCIALSE/INFO1 | TUC01 |
| | 23622 CALABASAS RD | |
| | CALABASAS CA 91302 | |
| | (800-487-4887) | |
| Sep. 29, 2003 | QuickenLoans/CHASECREDIT | TUC01 |
| | 6350 LAUREL CANYON | |
| | NORTH HOLLYWOO CA 91606 | |
| | (818-762-6262) | |
| Sep. 29, 2003 | CBABETATEST/CBASSOFIL | TUC01 |
| | IV EXECUTIVE CAMPU | |
| | CHERRY HILL NJ 08002 | |
| | (609-795-3211) | |
| Sep. 29, 2003 | CHOICEFINANC/CDS-MPCDEPT | TUC01 |
| | 2500 MAITLAND CENT | |
| | MAITLAND FL 32751 | |
| | (407-632-3365) | |
| Sep. 29, 2003 | GERRARD CORP | TUC01 |
| | 420 S. 5TH ST. | |
| | LA CROSSE WI 54602 | |
| | (608-782-1600) | |
| Sep. 29, 2003 | FNCS | TUC01 |
| | 918 ULSTER AVE | |
| | KINGSTON NY 12401 | |
| | (800-322-3880) | |
| Sep. 29, 2003 | GFSINC5116/1SOURCEDAT | TUC01 |
| | 2120 LAS PALMAS ST | |
| | CARLSBAD CA 92008 | |
| | (800-922-1301) | |
| Sep. 29, 2003 | LOANSOFTTESTACCOU/CBD | TUC01 |
| | 530 RIVERSIDE DR | |
| | SALISBURY MD 21801 | |
| | (410-742-9551) | |
| Sep. 28, 2003 | INNOVATIVESOFT/TUMRTGDPT | TUC01 |
| | 6111 OAK TREE BLVD | |
| | INDEPENDENCE OH 44131 | |
| | (216-643-3400) | |
| Sep. 26, 2003 | CBC MTG | TUC02 |
| | 170 E TOWER ST | |
| | COLOMBUS OH 43215 | |
| | (614-222-4319) | |
| Sep. 26, 2003 | ACS | TUC02 |
| | 8205 SPAIN NE | |
| | ALBUQUERQUE NM 87111 | |
| Sep. 26, 2003 | CTCS/TITL CR | TUC02 |
| | PO BOX 4410 | |
| | KINGSTON NY 12402 | |
| | (914-339-4053) | |
| Sep. 26, 2003 | RENTPORT, IN | TUC02 |
| | 5889 GREENWOOD PLA | |
| | GREENWOOD CO 80111 | |
| | (888-387-1750) | |
| Sep. 26, 2003 | DEMOCUSTOMER/DATAFAXCRDT | TUC01 |
| | IV EXECUTIVE CAMPU | |
| | CHERRY HILL NJ 08002 | |
| | (609-795-2221) | |
| Sep. 26, 2003 | WAYPOINTBANKM/CBYMTGDEPT | TUC01 |
| | MORTGAGE CODE | |
| | YORK PA 17401 | |
| | (717-843-8685) | |
| Sep. 26, 2003 | 293REGALMORTGAGE/CBCMTG | TUC01 |
| | 170 E TOWER ST | |
| | COLOMBUS OH 43215 | |
| | (614-222-4319) | |
| Sep. 26, 2003 | CARTERETMTG-COLUM/CDS | TUC01 |
| | 2500 MAITLAND CENT | |
| | MAITLAND FL 32751 | |
| | (818-881-5398) | |
| Sep. 25, 2003 | BRAD FRANCIS | TUC02 |
| | 499 EMILIO LOPEZ R | |
| | LOS LUNAS NM 87031 | |
| | (505-866-3100) | |
| Sep. 25, 2003 | RUOFFMORTGAGECOMPA/MCS | TUC01 |
| | 225 S. EAST STREET | |
| | INDIANAPOLIS IN 46202 | |
| | (317-264-3800) | |
| Sep. 25, 2003 | STREETSMARTZAUTOS/CREDCO | TUC01 |
| | 5626 RUFFIN ROAD | |
| | SAN DIEGO CA 92123 | |
| Sep. 25, 2003 | CBC MTG | TUC01 |
| | 170 E TOWER ST | |
| | COLOMBUS OH 43215 | |
| | (614-222-4319) | |
| Sep. 25, 2003 | CREDIT DATA | TUC01 |
| | 1451 HARTMAN | |
| | BOISE ID 83704 | |
| | (208-322-3000) | |
| Sep. 24, 2003 | SARMA | TUC01 |
| | 1801 BROADWAY | |
| | SAN ANTONIO TX 78215 | |
| Sep. 24, 2003 | EXECUTIVE MT | TUC01 |
| | 18 CROW CANYON CT | |
| | SAN RAMON CA 94583 | |
| | (925-831-0161) | |
| Sep. 24, 2003 | FLEXIBLEMORT/CDS-MPCDEPT | TUC01 |
| | 2500 MAITLAND CENT | |
| | MAITLAND FL 32751 | |
| | (407-632-3365) | |
| Sep. 24, 2003 | TRUSTWORTHYMORTGAGE/CDS | TUC01 |
| | 2500 MAITLAND CENT | |
| | MAITLAND FL 32751 | |
| | (818-881-5398) | |
| Sep. 24, 2003 | K & M WHLSLE | TUC01 |
| | 2909 EL CAMINO | |
| | SANTA MARGARIT CA 93453 | |
| | (805-438-3614) | |
| Sep. 24, 2003 | DEMOCUSTOMER/DATAFAXCRDT | TUC01 |
| | IV EXECUTIVE CAMPU | |
| | CHERRY HILL NJ 08002 | |
| | (609-795-2221) | |
| Sep. 24, 2003 | SUTTONPLACEAPTS/NTN | TUC01 |
| | 525 SW 1ST ST | |
| | LAKE OSWEGO OR 97035 | |
| | (800-228-0989) | |
| Sep. 24, 2003 | 376COLONIALHOMEFI/CBCMTG | TUC01 |
| | 170 E TOWER ST | |
| | COLOMBUS OH 43215 | |
| | (614-222-4319) | |
| Sep. 24, 2003 | TOBIN ASSOC | TUC01 |
| | 926 HADDON AVENUE | |
| | COLLINGSWOOD NJ 08108 | |
| Sep. 24, 2003 | CBABETATEST/CBASSOFIL | TUC01 |
| | IV EXECUTIVE CAMPU | |
| | CHERRY HILL NJ 08002 | |
| | (609-795-3211) | |
| Sep. 24, 2003 | AMERIFILENDING, I/FDNGSTE | TUC01 |
| | 4520 EXECUTIVE DRI | |
| | SAN DIEGO CA 92121 | |
| | (877-493-1938) | |
| Sep. 23, 2003 | CBABETATEST/CBASSOFIL | TUC01 |
| | IV EXECUTIVE CAMPU | |
| | CHERRY HILL NJ 08002 | |
| | (609-795-3211) | |
| Sep. 23, 2003 | COMMCOCREDIT/COMMCOCRDT | TUC01 |
| | 1156 N TUSTIN | |
| | ORANGE CA 92867 | |
| | (714-288-3535) | |

[CONSUMER STATEMENT]
TRANS UNION - BORROWER
FRAUD VICTIM DO NOT EXTEND CREDIT.
TRANS UNION - BORROWER
THIS IS A TEST FILE
TRANS UNION - BORROWER
THIS IS A TEST FILE
EXPERIAN - BORROWER
**#HK# ID SECURITY ALERT: FRAUDULENT APPLICATIONS MAY BE SUBMITTED IN MY NAME OR
MY IDENTITY MAY HAVE BEEN USED WITHOUT MY CONSENT TO FRAUDULENTLY OBTAIN GOODS
OR SERVICES. DO NOT EXTEND CREDIT WITHOUT FIRST CONTACTING ME PERSONALLY AND
VERIFYING ALL APPLICANT INFORMATION. THIS SECURITY ALERT WILL BE MAINTAINED FOR
90 DAYS BEGINNING May 01, 2002.
[CONSUMER REFERRAL INFORMATION]
EXPERIAN
P0 BOX 2002
ALLEN
TX
75013
(888) 397-3742
TRANS UNION
2 BALDWIN PL
P0 BOX 1000
CHESTER
PA
19022
(800) 916-8800
EQUIFAX
PO BOX 740241
ATLANTA
GA
30374
(800) 685-1111
This report was processed by Fidelity National Credit Svcs at 918 Ulster Avenue, Kingston, NY 12401 (800-322-3880) and contains
information provided by the repositories identified above. The contents have not been verified and may include duplicate information. This
report may be used for real estate lending purposes. This report is not a Residential Mortgage Credit Report as defined by FHA, VA, FNMA,
and FHLMC. It does, however, comply with announcement 89-13 regarding Timesaver Documentation.

| | |
|---|---|
| TEST FNCS WEB SOLUTION/KINGSTON | FILE NO: AHA99599 |
| | JONATHAN Q CONSUMER |

*** WORKSHEET ***

| CREDITOR | BALANCE | MONTHLY | BALANCE | SOURCE |
|---|---|---|---|---|
| ACCOUNT NUMBER | DATE | PAYMENT | AMOUNT | MOP |
| HOME FINANCIAL | 01/98 | 3128 | 234000 | EXP-01 |
| 24000098500012 | | | | M-1 |
| ORTEACHERFCU | 07/03 | 150 | 19550 | TUC-02 |
| 7770801 | | | | M-1 |
| ORTEACHERFCU | 07/03 | 0 | 150 | TUC-02 |
| 7770800 | | | | M-1 |
| | Real Estate Totals: | 3278 | 253700 | |
| MOUNTAIN BK | 12/96 | 956 | 19330 | EXP-01 |
| 3562A0197325346R12345 | | | | I-2 |
| CENTRAL BANK | 06/96 | 465 | 11050 | EXP-01 |
| 23802654388 | | | | I-2 |
| HEMLOCKS | 06/96 | 0 | 1000 | EXP-01 |
| 8285103111261 | | | | I-1 |
| GUADJARA JWL | 07/03 | 32 | 287 | TUC-02 |
| 128099 | | | | I-2 |
| | Installment Totals: | 1453 | 31667 | |
| STATE BANK | 06/96 | 255 | 8628 | EXP-01 |
| 4271008232 | | | | R-1 |
| EMPLOYEES CREDIT UNION | 01/98 | 180 | 6029 | EXP-01 |
| 525556601 | | | | R-1 |
| | Revolving Totals: | 435 | 14657 | |
| TROJAN PROFE | 07/01 | 0 | 615 | TUC-02 |
| 68111236545753243 | | | | O-9 |
| TAL LEWIS | 07/97 | 0 | 405 | TUC-01 |
| 20198 | | | | O-9 |
| CREDIT AND COLLECTION | 04/96 | 0 | 250 | EXP-01 |
| 98E543182136 | | | | U-9 |
| | Miscellaneous Totals: | 0 | 1270 | |
| | Grand Totals: | 5166 | 301294 | |

FOURTH REPOSITORY REPORT

| | |
|---|---|
| Match Code | = Matched Assessor Record |
| Fips Code | = 06053 |
| APN | = 261-713-005 |
| Property Address | = 460 BRIGHTON ST |
| City | = SALINAS |
| State | = CA |
| Zip | = 93907 |
| ZIP4 | = 2004 |
| Owner Name | = OROZCO, FERNANDO, |
| ASSESSMENT LEGAL | |
| Tract No. | = 971 |
| Description | = LAURENCE MEADOWS TRACT NO 971 LOT 5 |
| | BLK 2 |
| DEED LEGAL | |
| Lot Number | = 5 |
| Land Lot | = 2 |
| City, Municipality, Township | = SALINAS |
| Subdivision Name | = LAURENCE MEADOWS |
| Tract No. | = 971 |
| Recorder's Map Ref | = MB15 PG19 |
| VALUESURE DATA | |
| Estimated Market Value | = $347,100 |
| Low | = $329,700 |
| High | = $364,500 |
| Confidence | = HIGH |
| DEED RECORD PRIOR TRANSFER | |
| Recording Date | = Dec. 05, 2002 |
| Loan Amount | = $264,000 |
| Lender Name | = MIT LENDING |
| Interest Rate | = 50000.000000% |
| 2nd Loan Amount | = 33000 |
| Type Financing | = |
| MORTGAGE RECORDS | |
| MORTGAGE RECORD #1 | |
| Loan Amount | = $279,200 |
| Loan Type | = Unknown |
| Interest Rate | = |
| MORTGAGE RECORD #2 | |
| Loan Amount | = $26,800 |
| Loan Type | = Balloon |
| Interest Rate | = |

END OF FOURTH REPOSITORY REPORT

What is claimed is:

1. A method of generating a report for use in assessing the credit worthiness of a borrower in a potential financing transaction with a lender, comprising the steps of:
obtaining personal credit information about said borrower from a plurality of credit reporting services and combining said credit information;
matching said borrower's address with a property in a database containing property information and obtaining property information pertaining to said matched property from said database;
obtaining value information about said matched property;
aggregating said combined credit information about said borrower, said property information pertaining to said matched property and said value information pertaining to said matched property; and
generating said report from said aggregated data.

2. A method according to claim 1, wherein said step of obtaining personal credit information about said borrower includes connecting to and collecting information from at least three credit reporting agencies.

3. A method according to claim 2, wherein said collecting of information from at least three credit reporting agencies is done in parallel.

4. A method according to claim 1, wherein the step of obtaining property information pertaining to said matched property from said database includes at least one of an assessed value, a legal description, a number of bedrooms, a number of bathrooms and a type of construction of the matched property.

5. A method according to claim 1, wherein the step of matching said borrower's address with a property in a database further comprises selecting a database containing public record information on real property.

6. A method according to claim 1, wherein the step of obtaining value information about said matched property includes generating said value information using at least one of an assessed value, an appraised value of said matched property and historic valuation data of said matched property.

7. A method according to claim 2, wherein the step of aggregating includes combining the personal credit information collected from said at least three credit reporting agencies with said property information pertaining to said matched property and said value information pertaining to said matched property.

8. A method according to claim 1, further comprising a final step of communicating said report to a customer.

9. A report generated by the method of claim 1.

10. A program product for generating a report for use in assessing the credit worthiness of a borrower in a potential financing transaction with a lender, said product comprising machine-readable program code for causing, when executed, a machine to perform the following method steps:
obtaining personal credit information about said borrower from a plurality of credit reporting services and combining said credit information;
matching said borrower's address with a property in a database containing property information and obtaining property information pertaining to said matched property from said database;
obtaining value information about said matched property;
aggregating said combined credit information about said borrower, said property information pertaining to said matched property and said value information pertaining to said matched property; and
generating said report from said aggregated data.

11. A program product according to claim 10, wherein said step of obtaining personal credit information about said borrower includes connecting to and collecting information from at least three credit reporting agencies.

12. A program product according to claim 11, wherein said collecting of information from at least three credit reporting agencies is done in parallel.

13. A program product according to claim 10, wherein the step of obtaining property information pertaining to said matched property from said database includes at least one of an assessed value, a legal description, a number of bedrooms, a number of bathrooms and a type of construction of the matched property.

14. A program product according to claim 10, wherein the step of matching said borrower's address with a property in a database further comprises selecting a database containing public record information on real property.

15. A program product according to claim 10, wherein the step of obtaining value information about said matched property includes generating said value information using at least one of an assessed value, an appraised value of said matched property and historic valuation data of said matched property.

16. A program product according to claim 11, wherein the step of aggregating includes combining the personal credit information collected from said at least three credit reporting agencies with said property information pertaining to said matched property and said value information pertaining to said matched property.

17. A program product according to claim 10, further comprising a final step of communicating said report to a customer.
